(19) United States
(12) Patent Application Publication
(10) Pub. No.: US 2016/0358188 A1
(43) Pub. Date: Dec. 8, 2016

(54) DOWNSTREAM UTILITIES IN A WEBSITE USING MULTI-OBJECTIVE OPTIMIZATION

(71) Applicant: LinkedIn Corporation, Mountain View, CA (US)

(72) Inventors: ROMER E. ROSALES, Burlingame, CA (US); SHAUNAK CHATTERJEE, Sunnyvale, CA (US); YANG YANG, Fremont, CA (US); BEE-CHUNG CHEN, San Jose, CA (US); GUANGDE CHEN, Milpitas, CA (US); SHILPA GUPTA, Mountain Veiw, CA (US)

(21) Appl. No.: 14/729,903

(22) Filed: Jun. 3, 2015

(51) Int. Cl. G06Q 30/02; G06F 17/30; H04L 29/08

(52) U.S. Cl. CPC G06Q 30/0201; H04L 67/02; G06F 17/30905; G06F 17/30312; G06Q 30/0204; H04L 67/22

(57) ABSTRACT

In an embodiment, a method may comprise acquiring behavioral data of one or more users that suggests a causal relationship between source content and a request for destination content separated from the source content by one or more requests for intermediate content; and determining, based on the behavioral data, content to be placed on a web page. The method may also comprise determining, based on the behavioral data, a location on the web page to place the content. The method may comprise generating the behavioral data by associating a source URL with one or more subsequent URLs that are requested within a predetermined temporal proximity to a request for the source URL. The method may comprise generating the behavioral data by monitoring one or more user pseudonyms comprising a member identifier, a browser identifier, a computing platform identifier, a session identifier, a cookie, an IP address, or a geolocation.

### FIELD OF THE DISCLOSURE

Embodiments relate to content recommendation and, more specifically, to web page customization based on behavioral data.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

A user may cease viewing a web page for any number of reasons. For example, the user may become uninterested in content on the web page. As another example, the user may be inundated with too much content to pay attention to any particular content. Thus, the user may become bored and cease viewing the web page. As a result, a revenue opportunity may be missed, because an interested party, such as a publisher, a content creator, a retailer, and/or a manufacturer, may be unable to reach an interested audience. Furthermore, the interested party may be unable to appropriately price content and/or the location of content on the web page.

### BRIEF DESCRIPTION OF THE DRAWINGS

In the drawings:

FIG. 1 is a flow diagram that depicts an approach for optimizing a source web page.

FIG. 2 depicts an example causal relationship between source content and destination content separated by intermediate content.

FIG. 3 is a table that depicts an approach for generating behavioral data.

FIG. 4 depicts an approach for determining content and a location for the content.

FIG. 5 depicts an example computer architecture on which embodiments may be implemented.

FIG. 6 depicts a computer system upon which an embodiment may be implemented.

While each of the drawing figures depicts a particular embodiment for purposes of depicting a clear example, other embodiments may omit, add to, reorder, and/or modify any of the elements shown in the drawing figures. For purposes of depicting clear examples, one or more figures may be described with reference to one or more other figures, but using the particular arrangement depicted in the one or more other figures is not required in other embodiments.

A “computer” may be one or more physical computers, virtual computers, and/or computing devices. As an example, a computer may be one or more server computers, cloud-based computers, cloud-based cluster of computers, virtual machine instances or virtual machine computing elements such as virtual processors, storage and memory, data centers, storage devices, desktop computers, laptop computers, mobile devices, and/or any other special-purpose computing devices. A computer may be a client and/or a server. Any reference to “a computer” herein may mean one or more computers, unless expressly stated otherwise.

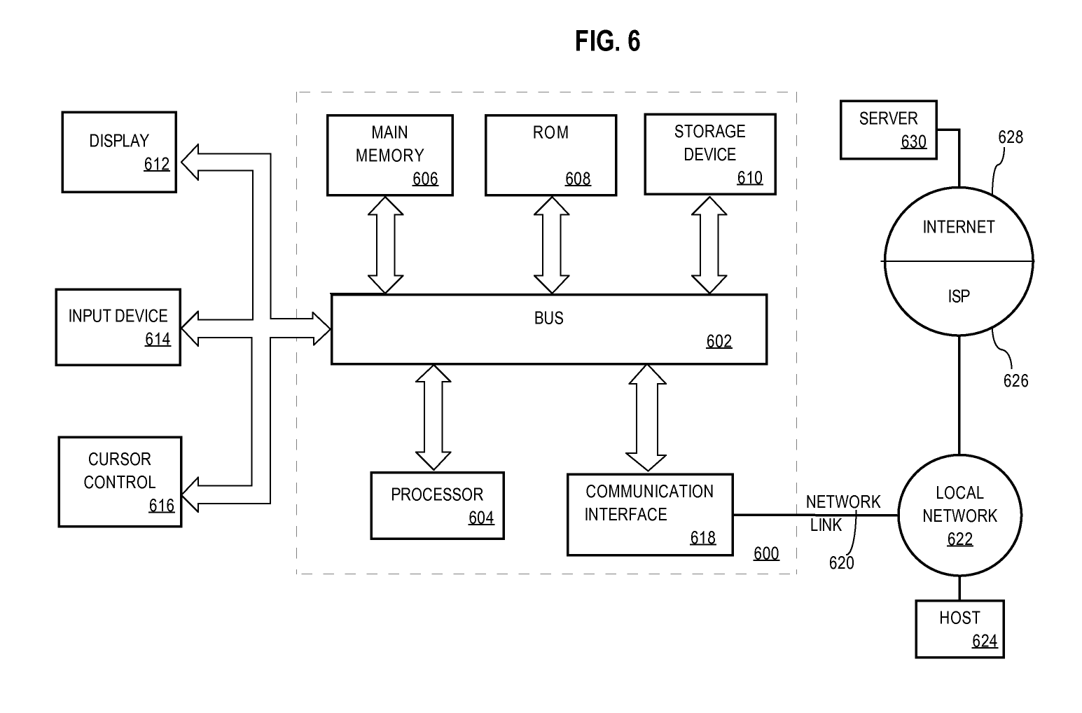

While some of the aforementioned elements are depicted in the figures and described herein as if implemented on a separate, remote computer from each other, this is done for explanation purposes only and one or more of the elements may be part of and/or executed on the same computer. Each of the logical and/or functional units depicted in the figures or described herein may be implemented using any of the techniques further described herein in connection with FIG. 6. For example, a computer may comprise a general-purpose computer configured with one or more stored programs which when executed cause performing the functions described herein for one or more logical and/or functional units; a special-purpose computer with digital logic that is configured to execute the functions; or digital logic that is used in other computing devices. While the figures include lines that indicate various devices and/or modules being communicatively coupled, each of the computers, devices, modules, storage, and logic may be communicatively coupled with each other.

### DETAILED DESCRIPTION

In the following description, for the purposes of explanation, numerous specific details are set forth in order to provide a thorough understanding of the present disclosure. It will be apparent, however, that the present disclosure may be practiced without these specific details. In other instances, well-known structures and devices are shown in block diagram form in order to avoid unnecessarily obscuring the present disclosure. Modifiers such as “first”, “second”, and “third” may be used to differentiate elements, but the modifiers do not necessarily indicate any particular order. For example, a second web page may be so named although, in reality, it may be a second, third, and/or fourth web page.

A system and method related to web page customization based on behavioral data are disclosed. A profile may be generated for one or more users of a website. The profile may include behavioral data of the one or more users. The behavioral data may be generated and/or acquired. The behavioral data may suggest that particular content on a particular web page will result in a plurality of web page requests that will ultimately lead to other content on another web page. Based on the behavioral data, content and/or location of the content may be determined for a web page. The content and/or the location of the content may be determined in a manner that simultaneously optimizes both user satisfaction and publishing revenues.

### General Overview

A source web page and a destination web page may be separated by one or more intermediate web pages. A web page publisher may wish to configure the source web page in a manner that predictably influences user behavior on the destination web page. User interactions with the source web page and the destination web page are tracked to determine attributes of the source web page (such as which content and where the content is located on the source web page) that tend to lead to certain user behavior with respect to the destination web page.

The source web page is customized for one or more users based on the tracked interactions. Customizing the source web page may involve determining source content to be placed on the source web page. Additionally or alternatively, customizing the source web page may involve determining one or more locations for the source content.

Customizing the source web page may be performed based on one or more objective functions. For example, an objective function may seek to maximize a probability of the one or more users requesting the destination web page. Multi-objective optimization (MOO) may be performed to customize the source web page based on multiple objective functions. For example, a second objective function may seek to simultaneously maximize publishing revenues.

### Process Overview

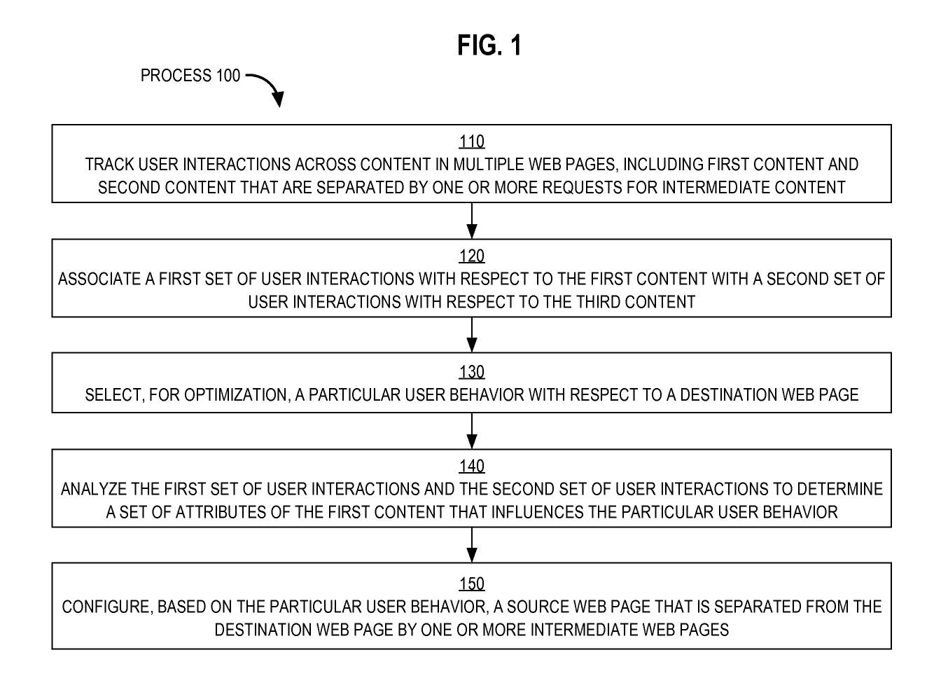

FIG. 1 is a flow diagram that depicts a process 100 for optimizing a source web page, in an embodiment.

At block 110, user interactions are tracked across content in multiple web pages. Examples of user interactions with respect to particular content may include requests for the particular content, views of the particular content, user selections of the particular content, and subscriptions for the particular content. The user interactions may be tracked based on a unique identifier, such as a member ID or a browser ID. Thus, a particular member ID is associated with a request for first content at time T1, one or more requests for intermediate content at time T2 (which is after T1), and a request for second content at time T3 (which is after T2).

At block 120, a first set of user interactions with respect to the first content are associated with a second set of user interactions with respect to the second content, even though the first content and the second content are separated by one or more requests for intermediate content. The association may be based on temporal proximity of the first and second set of interactions. Thus, the temporal proximity is used to presume a relationship between the first set of user interactions and the second set of user interactions.

At block 130, a particular user behavior with respect to a destination web page is selected. For example, an administrator may decide that the number of page views of the destination web page should be maximized. As another example, an administrator may decide that selecting sponsored content on a destination web page should be increased. Block 130 may involve receiving input that identifies the destination web page (or content on the destination web page) and the particular user behavior. In a related embodiment, multiple user behaviors with respect to the destination web page are selected for maximizing.

At block 140, the first and second set of user interactions are analyzed to determine a set of attributes of the first (or source) content that influences the selected user behavior with respect to content on the destination web page. In other words, the attributes of source content that tend to lead to the selected user behavior with respect to destination content are determined. The set of attributes of the source content may include a location of the source content on a web page, a type or category of the source content (e.g., business, finance, sports, entertainment), a media type of the source content (e.g., images, embedded video, graphics), etc. The user behavior with respect to the destination content may include viewing the destination content, selecting the destination content, subscribing to a particular service offered by the destination content, etc. If multiple user behaviors with respect to the destination content are tracked, then each user behavior may be associated with a different set of attributes of the source content.

At block 150, based on the selected user behavior, a source web page is configured. The source web page is located multiple “hops” or “requests” away from the destination web page. For example, if the particular user behavior with respect to a destination web page is viewing content of the destination web page, then the set of attributes of the source content may include a particular genre of the source content. Thus, the source web page may be configured to present content of the particular genre.

While process 100 is described in a particular order, the blocks of process 100 may be performed in a different order. For example, block 140 may be performed prior to block 130. Process 100 may repeat as necessary.

### Example Causal Relationship

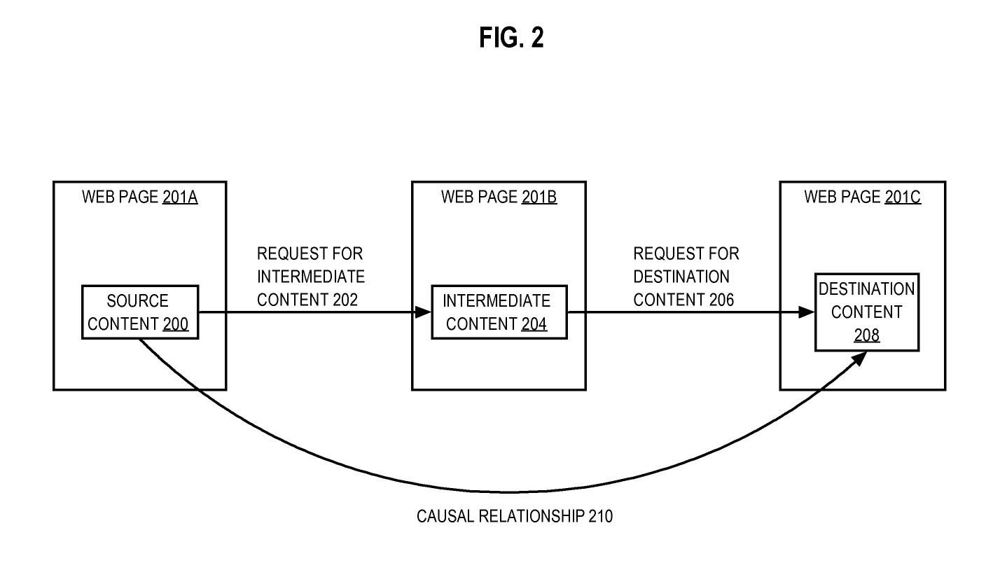

FIG. 2 depicts an example causal relationship between source content and destination content separated by intermediate content. In the example of FIG. 2, source content 200 on web page 201A is connected to intermediate content 204 on web page 201B via request for intermediate content 202. Intermediate content 204 is connected to destination content 208 on web page 201C via request for destination content 206. Source content 200 is connected to destination content 108 via causal relationship 210.

Source content 200 may be a news article, a hyperlink, a web feed, a digital image, an embedded video, an audio recording, an advertisement, and/or any other item presented to a user on web page 201A. Prior to, contemporaneously with, and/or subsequent to being presented with source content 200, the user may have logged into a website, accepted a tracking cookie, and/or otherwise provided identifying information about the user and/or a client computer used to present source content 200. The identifying information may be used to monitor user activity while and/or after the user is presented with source content 200. User activity may comprise clicking, reading, viewing, listening, and/or any other user interaction with content.

Each of web page 201A, 201B, 201C may be an instantiation of code that generates a web document. Each of web page 201A, 201B, 201C may be a real and/or virtual web page that is presented through a traditional browser, a mobile browser, and/or a native mobile app. Web page 201A, 201B, 201C represent a source web page, an intermediate web page, and a destination web page, respectively.

After being presented with source content 200, the user may send a request for one or more intermediate content 202 from the client computer and/or a different client computer associated with the user. Request for intermediate content 202 may be a Hypertext Transfer Protocol (HTTP) request, a Simple Object Access Protocol (SOAP) request, and/or any other request to a server computer for intermediate content 202. Intermediate content 204 may be a news article, a hyperlink, a web feed, a digital image, an embedded video, an audio recording, an advertisement, and/or any other item presented to a user on web page 201B.

After being presented with the one or more intermediate content 204, the user may send a request for destination content 206 from the client computer and/or another client computer associated with the user. Request for destination content 206 may be a HTTP request, a SOAP request, and/or any other request to a server computer for destination content 208. Destination content 208 may be a news article, a hyperlink, a web feed, a digital image, an embedded video, an audio recording, an advertisement, and/or any other item presented to a user on web page 201C.

The user activity from a time when the user is presented with source content 200 to a time when the user is presented with destination content 208, may suggest a causal relationship 210 between source content 200 and destination content 208. The user activity may be monitored and/or collected from a client computer through a client-side script. The user activity may be collected and/or analyzed to generate behavioral data that is stored in one or more user profiles. The behavioral data may be used to determine a probability, for one or more users, that being presented with source content 200 or similar content will result in being presented with destination content 208 or similar content. For example, the behavioral data may indicate that a photograph of a celebrity resulted in a request for a fan site of the celebrity. Thus, a video clip of a sports team may be similar content that is likely to result in a request for a fan site of the sports team.

### Generating Behavioral Data

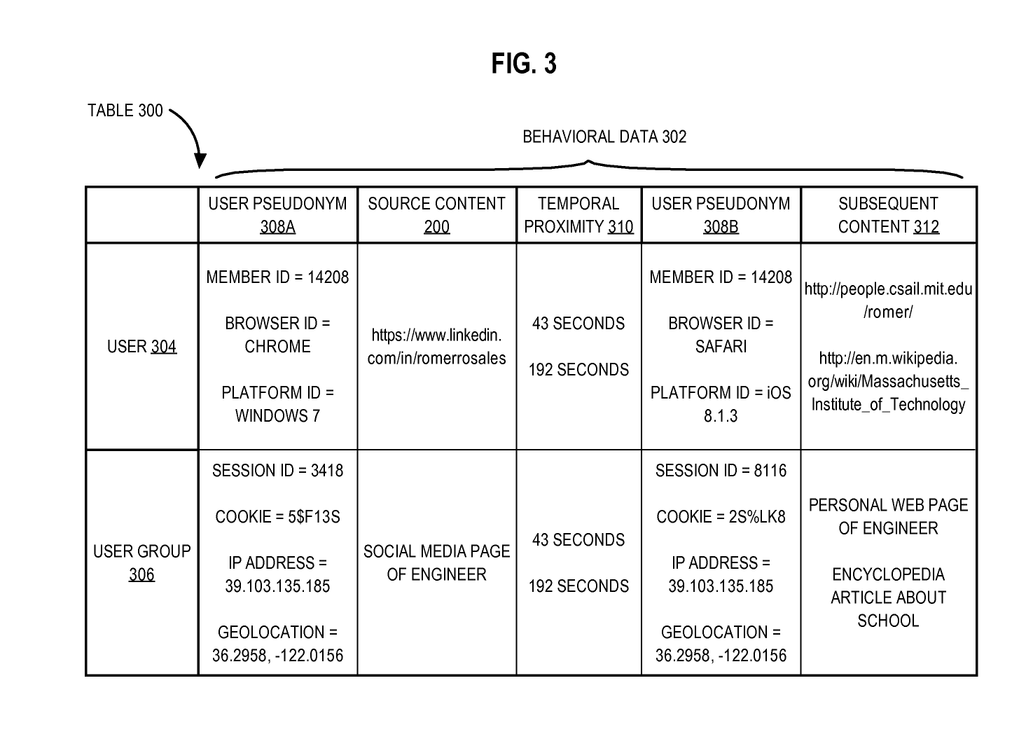

FIG. 3 is a table that depicts an approach for generating behavioral data. In the example of FIG. 3, table 300 depicts behavioral data 302 collected for user 304 and/or user group 306. Behavioral data 302 includes user pseudonym 308A, 308B, source content 200, temporal proximity 310, and subsequent content 312.

Behavioral data 302 may be information that describes one or more historical activities of one or more users. Behavioral data 302 may suggest, based on monitored user activity, one or more causal relationships between a plurality of content. For example, behavioral data 302 may suggest causal relationship 210 between source content 200 and subsequent content 312. Behavioral data 302 may be generated for one or more users. Additionally or alternatively, behavioral data 302 may be acquired from a third party that generates behavioral data 302. Behavioral data 302 may be generated based on an attribution model that associates source content 200 to one or more subsequent content 312. The attribution model may be based on time, number of intermediate web pages between source content 200 and subsequent content 312, and/or any other relevancy metric.

User 304 may represent a particular user that is presented with source content 200 or similar content, such as content that has been classified as similar to source content 200. For example, source content 200 may be a particular news article about France while other news articles that mention France may be classified as similar to source content 200. User 304 may be a user for whom a web page 201A, 201B, 201C will be customized. For example, web page 201A, 201B, 201C may be customized for user 304 based on historical activity involving similar content. Additionally or alternatively, user 304 may be a similar user to a user for whom a web page 201A, 201B, 201C will be customized. The similar user may be determined based on at least one of a group comprising demographics, activity level, or whether user 304 influences the user for whom a web page 201A, 201B, 201C will be customized.

User group 306 may represent a particular type of user that is presented with source content 200 or similar content. User group 306 may be generated based on one or more criteria, such as demographics, educational background, occupation, geolocation, interests, etc. For example, user group 306 may represent unmarried users in Mountain View, Calif., who have dogs. User group 306 may be determined by analyzing user data from a social network provider, such as LinkedIn, Facebook, or Google+.

User pseudonym 308A, 308B may comprise a member identifier, a browser identifier, a computing platform identifier, a session identifier, a cookie, an IP address, a geolocation, and/or any other information that, alone or in combination, uniquely identifies a user, a client computer, and/or a user agent. For example, the member identifier may uniquely identify a registered user of a particular website. User pseudonym 308A, 308B may be generated and/or obtained from a client computer through a client-side script.

Metadata comprising a timestamp, a content description, and/or user pseudonym 308A, 308B may be generated, stored, and/or associated with source content 200 and/or subsequent content 312. For example, source content 200 and subsequent content 312 may be presented in different client computers with different computing platforms and different browsers. Nevertheless, both source content 200 and subsequent content 312 may be associated with user 304 based on the same member identifier.

Temporal proximity 310 may be a length of time that separates source content 200 from subsequent content 312. Temporal proximity 310 may be used to generate behavioral data 302 based on a temporal attribution model. The temporal attribution model may associate source content 200 with any subsequent content 312 within a predetermined temporal proximity to source content 200. For example, any subsequent content 312 that is presented within a five minute time window in the future from when source content 200 is presented may be attributed to source content 200, thus suggesting a causal relationship 210 between source content 200 and subsequent content 312.

Subsequent content 312 may be a news article, a hyperlink, a web feed, a digital image, an embedded video, an audio recording, an advertisement, and/or any other item presented to a user on a web page 201B, 201C that is requested after source content 200 is presented. Subsequent content 312 may comprise intermediate content 204 and/or destination content 208. For example, FIG. 3 depicts two URLs as corresponding to subsequent content 312. The first URL may correspond to intermediate content 204 that is related to a source URL through a hyperlink. The second URL may correspond to destination content 208 that user 304 requested by manually entering the second URL into a browser address bar. Additionally or alternatively, subsequent content 312 and source content 200 may be associated with different web domains. In the example of FIG. 3, source content 200 is associated with a first web domain of “https://www.linkedin.com”, and subsequent content 312 is associated with a second web domain of “http://people.csail.mit.edu” or “http://en.m.wikipedia.org”.

Source content 200, intermediate content 204, destination content 208, and/or subsequent content 312 may comprise a URL, a link, a document, a file, and/or a content description. The content description may generalize and/or categorize source content 200, intermediate content 204, destination content 208, and/or subsequent content 312. In FIG. 3, source content 200 and subsequent content 312 for user group 306 are generalizations of a source URL and subsequent URLs for user 304. Thus, behavioral data 302 may be used to customize a web page 201A, 201B, 201C for a member of user group 306.

### User Behaviors with Respect to a Destination Web Page

A particular user behavior with respect to a destination web page is determined. Examples of user behavior include page views of the destination web page, selections of a particular type of content that is displayed on the destination web page, subscriptions for a particular service offered through the destination web page, and selections of advertisements presented on the destination web page.

The particular user behavior may be determined automatically or based on user input. For example, an administrator is presented with multiple pre-defined user behaviors through a user interface and selects one or more of the user behaviors. As another example, the particular user behavior is a default user behavior (e.g., page views) that may be changed through user input.

### Determining Attributes of a Source Web Page

Once the one or more user behaviors are determined, attributes of a source web page may be determined using one of multiple approaches. In one approach, behavioral data 302 is analyzed to identify “upstream” user behavior (i.e., user behavior with respect to source content) that has led to the particular user behavior with respect to the destination content. For example, analysis of behavioral data 302 may indicate that 70% of subscriptions (in a particular month) of a service offered on a destination web page originated from users viewing a version of a source web page that contained a first content item, 20% of subscriptions of the service originated from users viewing another version of the source web page that contained a second content item, and 10% of subscriptions of the service originated from users viewing a third version of the source web page that contained a third content item. In this example, to maximize subscriptions of the service, it is determined that the source web page should be optimized to always include the first content item.

The source content upon which behavioral data 302 is based may have been located on the source web page that is the target of customization. Alternatively, the source content may have been on a different web page. Thus, the source web page that is being customized may not have ever included, in the past, the source content or even the type of source content.

In an embodiment, this type of analysis may be performed in a manner that is agnostic about user profile information. Thus, all users are treated the same. In a related embodiment, this analysis may be performed for groups of users, each group consisting of users that satisfy one or more grouping criteria. Examples of grouping criteria include having a particular job title or function, having a particular academic degree, being a member of a social network for a particular period of time, residing in a particular geographic location, having a salary in a particular range, being a member of a particular organization, etc. The grouping criteria may be determined based on profile data that the users provide to a social network.

Thus, in this grouping embodiment, a source web page is customized differently for different groups of user. In other words, users belonging to different groups may see or experience different versions of the same source web page. For example, one user group may be users with a particular job title and another user group may be users with a particular academic degree. If a particular user belongs (or maps) to multiple user groups, then one of the user groups is selected in order to determine how to customize the source web page for the particular user. To assist in selecting a user group, each user group may be associated with priority data that indicates which user group has a higher priority than another user group in case a user belongs to multiple user groups.

Additionally or alternatively, at least some user groups are associated with multiple matching criteria. Thus, comparing user profile data with user group matching criteria may result in a partial match. Therefore, for a particular user, the user group to which the particular user most closely matches is selected in order to determine how to customize the source web page.

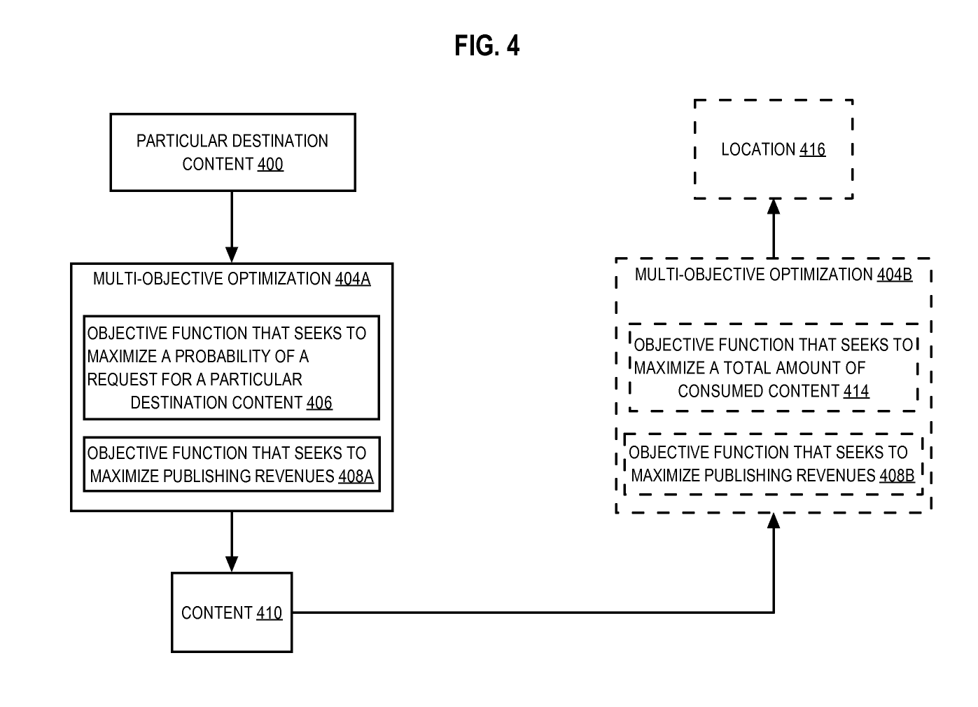

FIG. 4 depicts another approach for determining content and/or a location for the content. In the example of FIG. 4, particular destination content 400 is provided as input to a multi-objective optimization 404A comprising an objective function 406 that seeks to maximize a probability of a request for a particular destination content and an objective function 408A that seeks to maximize publishing revenues. Multi-objective optimization 404A outputs content 410, which is optionally provided as input to multi-objective optimization 404B comprising an objective function 414 that seeks to maximize a total amount of consumed content and an objective function 408B that seeks to maximize publishing revenues. Multi-objective optimization 404B outputs location 416.

Particular destination content 400 may be a news article, a hyperlink, a web feed, a digital image, an embedded video, an audio recording, an advertisement, and/or any other item that is to be presented to a user on a web page 201C that is to be requested after content 410 is presented. For example, content 410 may be particular source content and/or one or more particular intermediate content that, based on behavioral data 302, is likely to result in a request for particular destination content 400. Particular destination content 400 may be provided as input to a multi-objective optimization 404A, 404B and/or an objective function 406, 408A, 408B, 414. Content may be referenced as a URL and/or any other content identifier. For example, particular destination content 400 may be provided as input in the form of a content identifier that includes an alphanumeric string uniquely referencing an available content item.

Additionally or alternatively, input to a multi-objective optimization 404A, 404B and/or an objective function 406, 408A, 408B, 414 may include a particular source web page, a number of requests that separate the particular source web page from a particular destination web page, behavioral data 302, a set of possible content for the particular source web page, and/or a set of possible locations for content on the particular source web page. The particular source web page may be provided as input in the form of a reference to the particular source web page, such as a URL. Selecting the particular source web page may limit the set of possible content for the particular source web page. For example, the particular source web page may be associated with a particular genre of content, thereby limiting the set of possible content for the particular source web page to content related to the particular genre. The set of possible locations for content on the particular source web page may be provided as input in the form of web page element identifiers. For example, a location corresponding to “<td id=‘node1’></td>” may be referenced as “node1”.

In an embodiment, a particular source web page may be provided as input to multi-objective optimization 404A or 404B. In this embodiment, behavioral data 302 may be used to predict user interactions with respect to subsequent content 312 on subsequent web pages. For example, objective function 414 may model behavioral data 302 and predict user interactions that stem from content on the particular source web page.

In an embodiment, particular destination content 400 and a number of requests that separate the particular source web page from a particular destination web page may be provided as input to multi-objective optimization 404A, 404B that includes objective function 406. In this embodiment, behavioral data 302 may be used to determine a particular source content that is most likely to result in a request for particular destination content 400 that is a specified number of “hops” from the particular source content. For example, objective function 406 may model behavioral data 302 and predict that the particular source content has a 93% probability of resulting in a request for particular destination content 400, which is located three “hops” away from the particular source content.

Multi-objective optimizations 404A, 404B may be performed by a web server and/or a user simulator. Each of multi-objective optimizations 404A, 404B may be an optimization algorithm that involves simultaneously optimizing a plurality of objective functions. Many times the interests of the user, the publisher, the content creator, the retailer, and/or the manufacturer conflict. Thus, multi-objective optimization 404A, 404B may simultaneously optimize those interests. Multi-objective optimization 404A, 404B may involve one or more compromises between those interests. For example, multi-objective optimization 404A, 404B may seek to maximize the total number of article reads subject to the constraints that advertising revenues remain above $1 million and that feed clicks remain above two million per week. In another example, multi-objective optimization 404A, 404B may seek to maximize both a total amount of consumed content on a particular computing platform as well as a total number of actions on a source web page. In yet another example, multi-objective optimization 404A, 404B may seek to maximize both a total number of web pages and/or URLs visited as well as a total number of actions on a source web page. In still another example, multi-objective optimization 404A, 404B may seek to maximize both a total number of social media connection invitations sent as well as a total number of actions on a source web page. Actions on a source web page may comprise a click action, a “like” action (e.g., an expression of approval), a comment action, and/or a share action.

Objective function 406 (that seeks to maximize a probability of a request for particular destination content) may be a parameter in an optimization algorithm. Objective function 406 may seek to maximize a desired user behavior on a destination web page. Selecting, for optimization, a particular user behavior with respect to a destination web page may comprise selecting an objective function 406. Objective function 406 may be a mathematical equation that is derived from behavioral data 302.

Objective function 406 may be constrained by another parameter in the optimization algorithm in a manner such that objective function 406 is optimized relative to another parameter. For example, objective function 406 may be trivially optimized by ensuring that particular destination content 400 is the only item that may be requested. However, if objective function 406 is constrained by another parameter that seeks to maximize advertising revenues, ensuring that particular destination content 400 is the only item that may be requested would be eliminated from a set of optimal solutions.

Objective function 408A (i.e., that seeks to maximize publishing revenues may be a parameter in an optimization algorithm. Objective function 408A may be constrained by another parameter in the optimization algorithm in a manner such that objective function 408A is optimized relative to the another parameter. For example, objective function 408A may be optimized by publishing content 410 associated with the highest bidders. However, if objective function 408A is constrained by another parameter that seeks to maximize web traffic, then publishing content 410 associated with the highest bidders may be eliminated from a set of optimal solutions.

Content 410 may be a news article, a hyperlink, a web feed, a digital image, an embedded video, an audio recording, an advertisement, and/or any other item presented to a user on a web page 201A, 201B, 201C. Content 410 may comprise source content 200, intermediate content 204, destination content 208, and/or subsequent content 312. Additionally or alternatively, content 410 may be similar to source content 200, intermediate content 204, destination content 208, subsequent content 312, and/or particular destination content 400.

Objective function 414 (i.e., that seeks to maximize a total amount of consumed content) may be a parameter in an optimization algorithm. Objective function 414 may seek to maximize a desired user behavior on a destination web page. Selecting, for optimization, a particular user behavior with respect to a destination web page may comprise selecting an objective function 414. Objective function 414 may be a mathematical equation that is derived from behavioral data 302.

Objective function 414 may be constrained by another parameter in the optimization algorithm in a manner such that objective function 414 is optimized relative to the another parameter. A total amount of consumed content may comprise a total number of articles read, a total number of images viewed, a total number of videos rendered, a total number of audio recordings rendered, and/or a total number of pages viewed. The total amount of consumed content may be determined based on a total number of requests and/or a time between requests. The total number of requests and/or the time between requests may be collected from a client computer through a client-side script.

Location 416 corresponds to a position on one of web pages 201A, 201B. Location 416 may be a node in a Document Object Model (DOM). A location 416 may correspond to a particular probability of user interaction with content 410. For example, a position at the top of a list ordered by probability may correspond to a greater probability of user interaction than a position at the bottom of a list.

### Example Computer Architecture

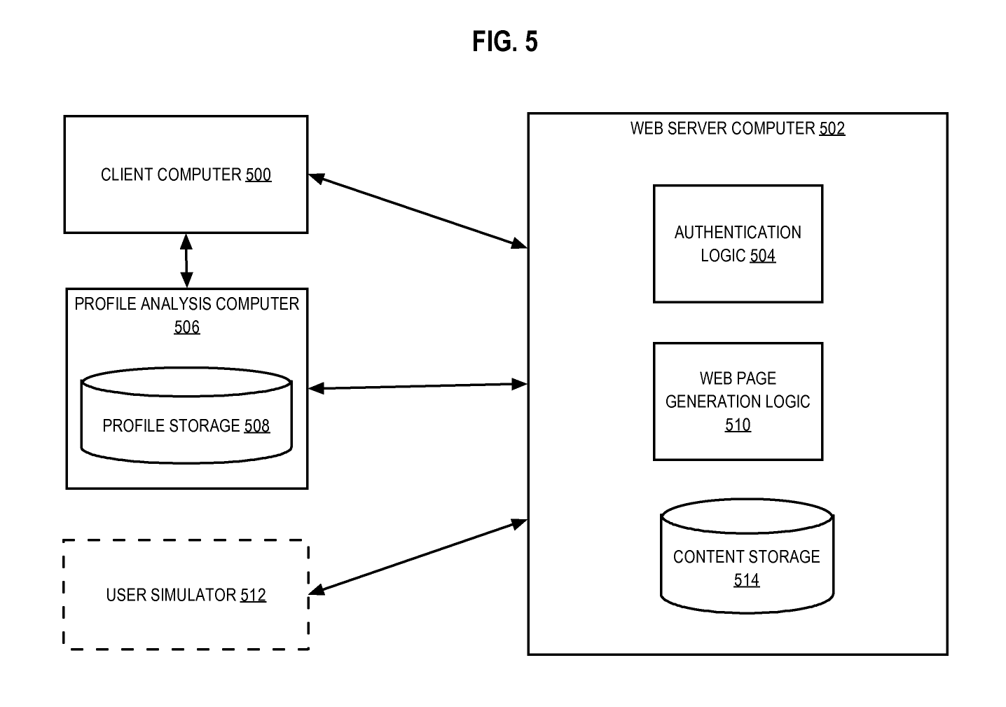

FIG. 5 depicts an example computer architecture on which embodiments may be implemented. In the example of FIG. 5, client computer 500 is communicatively coupled to web server computer 502 comprising authentication logic 504, web page generation logic 510, and content storage 514. Web server computer 502 is also communicatively coupled to profile analysis computer 506 comprising profile storage 508. User simulator 512 is also communicatively coupled to web server computer 502. In an embodiment, profile analysis computer 506 may also be communicatively coupled to client computer 500.

Client computer 500 may be a desktop computer, a laptop computer, a smartphone, a tablet computer, a smart television, and/or any other networked computer that acts as a client. Client computer 500 may comprise a user agent, such as a browser, through which a user may interact with content 410 on a web page 201A, 201B, 201C. A web page 201A, 201B, 201C may comprise one or more client-side scripts that monitor user activity and/or one or more user pseudonyms. For example, the one or more client-side scripts may collect URLs, timestamps, member identifiers, browser identifiers, computing platform identifiers, session identifiers, cookies, IP addresses, and/or geolocations. The one or more client-side scripts may send collected information to web server computer 502 and/or profile analysis computer 506.

Web server computer 502 comprises one or more server computers and/or one or more load balancers. Web server computer 502 may comprise a networked computer that acts as a server to one or more clients, such as client computer 500. Web server computer 502 may receive requests for data and may respond with data. Web server computer 502 may be owned and/or managed by one or more independent entities and may span across one or more computer networks, such as the Internet. Additionally or alternatively, web server computer 502 may respond with data that references data on web server computer 502 and/or another computer.

Authentication logic 504 processes the collected information from the one or more client-side scripts and/or client computer 500. Authentication logic 504 may identify the user of client computer 500 based on the one or more user pseudonyms. Authentication logic 504 sends a subset (e.g., none, some, all) of the collected information to profile analysis computer 506.

Profile analysis computer 506 generates behavioral data 302 of one or more users. Profile analysis computer 506 processes the collected information from the client computer 500 and/or the subset of the collected information sent from web server computer 502. Profile analysis computer 506 associates source content 200 with one or more subsequent content 312 that is/are requested within a predetermined temporal proximity to a request for source content 200. Behavioral data 302 suggests causal relationship 210 between source content 200 and request for destination content 206 that is separated from source content 200 by at least one request for intermediate content 202. Profile analysis computer 506 may associate behavioral data 302 with one or more user profiles based on the one or more user pseudonyms. Profile analysis computer 506 may store behavioral data 302 and/or the one or more user profiles in profile storage 508. Additionally or alternatively, profile analysis computer 506 may send behavioral data 302 and/or the one or more user profiles to web server computer 502.

Profile analysis computer 506 and/or profile storage 508 may be a database, a configuration file, and/or any other system and/or data structure that stores data. Profile storage 508 may be on a separate device from profile analysis computer 506. Additionally or alternatively, profile storage 508 may be a data structure stored in memory on the one or more computers comprising, at least in part, profile analysis computer 506. Additionally or alternatively, profile storage 508 may, at least in part, be a data structure stored in shared memory between one or more computers. Additionally or alternatively, profile storage 508 may be, at least in part, non-volatile storage. Web server computer 502, profile analysis computer 506, and/or profile storage 508 may be owned and/or managed by one or more independent entities and may span across one or more computer networks, such as the Internet.

Web page generation logic 510 processes behavioral data 302 and/or the one or more user profiles. Web page generation logic 510 may generate a web page 201A, 201B, 201C based on behavioral data 302 and/or the one or more user profiles. Web page generation logic 510 may determine content 410 to be placed on a web page 201A, 201B, 201C based on an optimization algorithm. The optimization algorithm may be based on one or more objective functions comprising objective function that seeks to maximize a probability of a request for a particular destination content 400, objective function 408A (i.e., that seeks to maximize publishing revenues), objective function 414 (i.e., that seeks to maximize a total amount of consumed content), and/or an objective function seeking to maximize a total number of requests for subsequent content. The optimization algorithm may comprise a multi-objective optimization.

Content 410 may be retrieved from content storage 514. Web page generation logic 510 and/or web server computer 502 may optionally send content 410 to user simulator 512. Web page generation logic 510 may also determine, based on an optimization algorithm, location 416 for content 410 on a web page 201A, 201B, 201C. The optimization algorithm may be based on one or more objective functions described herein. The optimization algorithm may comprise a multi-objective optimization.

Optional user simulator 512 is a computer and/or software that models user behavior. User simulator 512 may be used to model user behavior off-line. User simulator 512 may determine content 410 to be placed on a web page 201A, 201B, 201C based on an optimization algorithm. The optimization algorithm may be based on one or more objective functions described herein. The optimization algorithm may comprise a multi-objective optimization.

User simulator 512 may also determine, based on an optimization algorithm, location 416 for content 410 on a web page 201A, 201B, 201C. The optimization algorithm may be based on one or more objective functions described herein. The optimization algorithm may comprise a multi-objective optimization.

Web server computer 502 and/or content storage 514 may be a database, a configuration file, and/or any other system and/or data structure that stores data. Content storage 514 may be a separate computer from web server computer 502. Additionally or alternatively, content storage 514 may be a data structure stored in memory on the one or more computers comprising, at least in part, web server computer 502. Additionally or alternatively, content storage 514 may, at least in part, be a data structure stored in shared memory between one or more computers. Additionally or alternatively, content storage 514 may be, at least in part, non-volatile storage.

### Implementation Examples

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 6 is a block diagram that depicts a computer system 600 upon which an embodiment may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
storing first behavioral data that indicates a first set of interactions of a set of users with respect to first content;
storing second behavioral data that indicates a second set of interactions of the set of users with respect to second content that is separated from the first content by one or more requests for intermediate content;
determining to store an association between the first behavioral data and the second behavioral data;
identifying a particular user behavior with respect to a destination web page;
based on the association between the first behavioral data and the second behavioral data and the particular user behavior with respect to the destination web page, determining one or more attributes of a source web page that is separated from the destination web page by one or more intermediate web pages;
wherein the method is performed by one or more computing devices.

2. The method of claim 1, wherein determining the one or more attributes comprises determining particular content to be displayed on the source web page.

3. The method of claim 1, wherein determining the one or more attributes of the source web page comprises using a first objective function that is based on the first and second behavioral data and that seeks to maximize a probability of a request for particular destination content on the destination web page.

4. The method of claim 3, wherein determining the one or more attributes of the source web page comprises performing a multi-objective optimization that uses the first objective function and a second objective function that seeks to maximize publishing revenues.

5. The method of claim 1, wherein determining the one or more attributes comprises determining a location, on the source web page, to place certain content.

6. The method of claim 5, wherein determining the location comprises performing a multi-objective optimization using a first objective function that seeks to maximize a total amount of consumed content and a second objective function that seeks to maximize publishing revenues.

7. The method of claim 1, wherein determining to store the association between the first behavioral data and the second behavioral data comprises determining that one or more subsequent Uniform Resource Locators (URLs) are requested within a predetermined temporal proximity to a request for a source URL.

8. The method of claim 1, wherein the first behavioral data and the second behavioral data are generated by monitoring one or more user pseudonyms comprising a member identifier, a browser identifier, a computing platform identifier, a session identifier, a cookie, an Internet Protocol (IP) address, or a geolocation.

9. The method of claim 1, wherein the first content is associated with a first web domain and the second content is associated with a second web domain that is different than the first web domain.

10. The method of claim 1, wherein the first content and the second content are associated with different computing platforms.

11. The method of claim 1, further comprising, after the source web page is modified based on the one or more attributes:
identifying a second user behavior with respect to the destination web page, wherein the second user behavior is different than the particular user behavior;
based on the second user behavior with respect to the destination web page and the association between the first behavioral data and the second behavioral data, determining one or more second attributes of the source web page.

12. A system comprising:
one or more processors; and
one or more non-transitory storage media storing instructions which, when executed by the one or more processors, cause a particular party to perform:
storing first behavioral data that indicates a first set of interactions of a set of users with respect to first content;
storing second behavioral data that indicates a second set of interactions of the set of users with respect to second content that is separated from the first content by one or more requests for intermediate content;
determining to store an association between the first behavioral data and the second behavioral data;
identifying a particular user behavior with respect to a destination web page;
based on the association between the first behavioral data and the second behavioral data and the particular user behavior with respect to the destination web page, determining one or more attributes of a source web page that is separated from the destination web page by one or more intermediate web pages.

13. The system of claim 12, wherein determining the one or more attributes comprises determining particular content to be displayed on the source web page.

14. The system of claim 12, wherein determining the one or more attributes of the source web page comprises using a first objective function that is based on the first and second behavioral data and that seeks to maximize a probability of a request for particular destination content on the destination web page.

15. The system of claim 14, wherein determining the one or more attributes of the source web page comprises performing a multi-objective optimization that uses the first objective function and a second objective function that seeks to maximize publishing revenues.

16. The system of claim 12, wherein determining the one or more attributes comprises determining a location, on the source web page, to place certain content.

17. The system of claim 16, wherein determining the location comprises performing a multi-objective optimization using a first objective function that seeks to maximize a total amount of consumed content and a second objective function that seeks to maximize publishing revenues.

18. The system of claim 12, wherein determining to store the association between the first behavioral data and the second behavioral data comprises determining that one or more subsequent Uniform Resource Locators (URLs) are requested within a predetermined temporal proximity to a request for a source URL.

19. The system of claim 12, wherein the first behavioral data and the second behavioral data are generated by monitoring one or more user pseudonyms comprising a member identifier, a browser identifier, a computing platform identifier, a session identifier, a cookie, an Internet Protocol (IP) address, or a geolocation.

20. The system of claim 12, wherein the first content is associated with a first web domain and the second content is associated with a second web domain that is different than the first web domain.

21. The system of claim 12, wherein the first content and the second content are associated with different computing platforms.

22. The system of claim 12, further comprising instructions which, when executed by the one or more processors after the source web page is modified based on the one or more attributes, cause:
identifying a second user behavior with respect to the destination web page, wherein the second user behavior is different than the particular user behavior;
based on the second user behavior with respect to the destination web page and the association between the first behavioral data and the second behavioral data, determining one or more second attributes of the source web page.
